(19) United States
(12) Patent Application Publication
(10) Pub. No.: US 2009/0188261 A1
(43) Pub. Date: Jul. 30, 2009

(54) Limiter for Limiting the Motion of Components in a Cryostat

(75) Inventors: Nicholas Mann, Compton (GB); Neil Charles Tigwell, Witney (GB); Stephen Paul Trowell, Finstock (GB)

Correspondence Address: CROWELL & MORING LLP;INTELLECTUAL PROPERTY GROUP, P.O. BOX 14300, WASHINGTON, DC, 20044-4300, US

(73) Assignee: Siemens Magnet Technology Ltd., Eynsham (GB)

(21) Appl. No.: 12/350,515

(22) Filed: Jan. 8, 2009

(30) Foreign Application Priority Data
Jan. 24, 2008 (GB) 0801255.1

(51) Int. Cl. F17C 3/00; F16F 15/00

(52) U.S. Cl. 62/51.1; 62/297; 248/544

(57) ABSTRACT

A limiter is provided to limit the motion of components in a cryostat during transit. This permits the use of a support structure which minimises the disturbance to an insulating structure and thus reduces ingress of heat to the cryogen. Cryogen loss is reduced leading to lower operating costs.

This invention relates to a superconducting magnet, such as used in a Magnetic Resonance Imaging system and in particular to a cryostat for such a magnet which minimises heating of cryogen held within the cryostat.

Magnetic Resonance Imaging (MRI) imaging systems utilise large superconducting magnets which require cooling to liquid helium temperatures for successful operation. A cryostat is provided to enclose the magnet and to hold a large volume of the liquid helium to provide the cooling. Liquid helium is very expensive and thus the cryostat structure is designed to minimise its loss through heating from the environment where the imaging system is located. A multilayer structure is provided which is designed to prevent heat passing into the helium by conduction, convection and radiation.

The structure comprises a helium vessel which is innermost, a radiation shield spaced apart form the helium vessel, a number of layers of aluminised polyester sheet (Mylar(RTM) foil) and insulation mesh, and then the outer vessel. This structure is evacuated during manufacture to minimise heat transfer from the outer vessel by convection and conduction.

To support the helium vessel in a spaced apart relationship to the radiation shield and the outer vessel it is known to provide a support structure, for example comprising carbon fibre bands. These extend from brackets welded to the outer surface of the helium vessel to brackets formed on the inner surface of the outer vessel. The bands extend through the radiation shield and the various layers of reflective Mylar(RTM) aluminised polyester sheet and insulation mesh at an angle to provide sufficient bracing against movement during transport of the magnet to its site of operation. To cater for the possibility of poor handling during shipping, the bands have to be provided in sufficient numbers and strengths to prevent, or at least restrain, relative movement of the helium vessel with respect to the outer vessel. Five G impacts are factored for in the design although once installed the bands will just have a maximum loading of just one G. Thus, the bands are in effect over-engineered to cater for handling during transport to an extent that far exceeds the loading they will experience once the imaging system is installed.

It will now be appreciated that in order to cater for the handling loads by providing such bands or similar structures, a large number of holes will be created through the insulation and the radiation shield and these will provide pathways for radiation and conduction of heat to the helium vessel which will lead to heating of the vessel. A loss of helium will therefore result which adds significantly to the running costs of the imaging system.

The present invention arose in an attempt to alleviate this problem.

According to the invention there is provided a cryostat comprising a set of superconducting magnet coils, a cryogen vessel for containing cryogen for cooling the superconducting magnet coils, an outer vessel containing the cryogen vessel and an insulation structure disposed between the outer vessel and the cryogen vessel, a support structure within the outer vessel for supporting the cryogen vessel in spaced apart relationship to the outer vessel and a limiter for limiting relative movement of the cryogen vessel with respect to the outer vessel. The limiter has a deployed condition and a stowed condition. When in the deployed condition, the relative movement of the cryogen vessel is limited by the limiter and when in a stowed condition, the relative movement is limited by the support structure. The limiter moves between at least one of the deployed and stowed conditions to the other of the deployed and stowed conditions in response to the generation of a magnetic field by the superconducting magnet coils.

By providing a limiter for limiting the relative movement, it is possible to provide movement limitation during transit. The limiter may be stowed once the magnet has been located at its site of use. This means that the support structure may be optimised for use when the imaging system is installed rather than for catering for excessive loads during transit. Accordingly, the effect of the support structure on the insulation of the cryogen vessel at its site of use is reduced.

In the described embodiment of the invention, the support structure is a set of carbon fibre bands as known in the prior art but these are fewer in number and/or gauge than in known arrangements. Alternative support arrangements, known in themselves, such as carbon fibre rods, steel rods or bands, fibreglass rods or bands, may be used and may each be used in smaller number than in conventional systems, as a result of the present invention. The cross section of the elements of the support structure may also, or alternatively, be reduced. Accordingly, the insulation structure is more efficient since the holes created in it are fewer and/or smaller. Furthermore, the cost of the support structure is reduced. The insulating structure in the described embodiment comprises a radiation shield and layers of aluminised sheet, and is evacuated.

The cryogen vessel in the described embodiment is designed to hold helium but other cryogens may be used depending upon the imaging system magnet properties.

Preferably, the limiter is provided for limiting relative movement of the helium vessel, and is deployed by a spring bias.

Preferably, the limiter will be moved to a stowed position using attractive force provided by operation of the imaging system magnets. This is advantageous since it avoids the need to provide other motive power to return the limiter to a stowed position.

A specific embodiment of the invention will now be described by way of example only, with reference to the drawings of which:

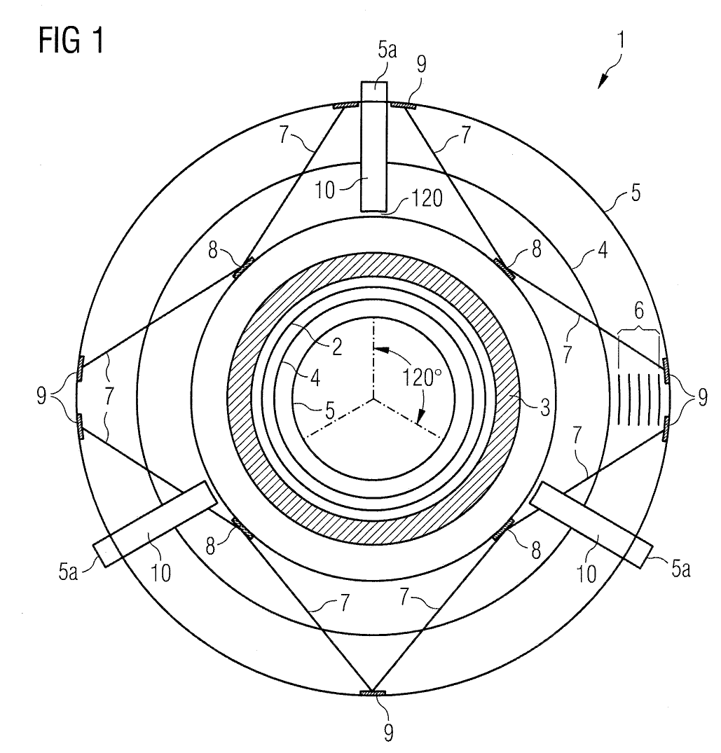

FIG. 1 shows a imaging system in accordance with the invention showing a support structure of carbon fibre bands and limiters; and

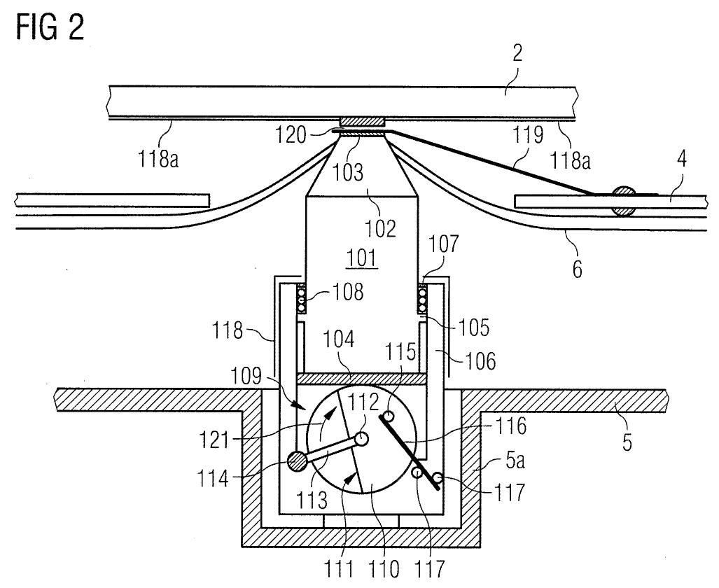

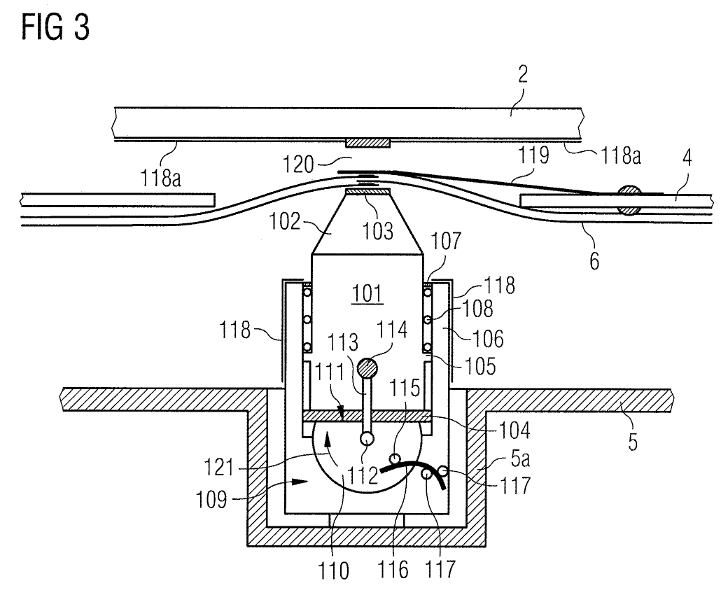

FIG. 2 and 3 respectively show a limiter in accordance with the invention in a deployed and stowed condition respectively.

As is shown in FIG. 1, a cryostat 1 containing a cooled superconducting magnet comprises a helium-containing cryogen vessel 2 surrounding magnet coils 3, a radiation shield 4 of high grade aluminium and an outer vessel 5. The space between the outer vessel 5 and the radiation shield 4 is filled by a plurality of reflective aluminised polyester (Mylar(RTM)) sheets 6 interspaced with an insulating matrix material. The space between the helium vessel 2 and the outer vessel 5 is evacuated to prevent heat transfer by convection.

References to “inner” and “outer” refer to the radial direction of the cryostat 1 as a whole.

The helium vessel 2 is supported in a spaced apart relationship to the other components by a series of carbon fibre bands 7. These pass through the radiation shield 4 and the insulation layers 6 between respective brackets 8 and 9 on the helium vessel 2 and outer vessel 5 respectively. According to an aspect of the present invention, the bands 7 are designed to take a loading of only 1.5 G.

Spaced, preferably equiangularly, about the circumference of the helium vessel 2 are three motion limiters 10. These are shown in the figure in their deployed state where they are separated at their inner ends from the helium vessel by a small clearance gap 120 and are fixed into cups 5a in the profile of the outer vessel 5. If the helium vessel 2 moves during transit beyond the dimension of the clearance gap 120 then it will be stopped by the inner end of at least one limiter 10, with the mechanical load transferred outwards into the outer vessel 5 by the limiter.

FIG. 2 shows one of the limiters 10 in greater detail in its deployed state. It can be seen that the limiter comprises a piston 101 having a generally cylindrical shape with an innermost portion 102 which is a truncated cone shape. The piston is formed of a non-magnetic material of low thermal conductivity, such as glass re-enforced plastic, to prevent heat conduction along its length. The piston has an inner end face formed by a metal disc 103 and an outer bearing face 104 also of metal. Other hard-wearing materials may be chosen. At least one radial extension of the outer surface of the piston provides at least one bore riding ring 105. This in conjunction with the bearing surface 104 allows the piston 101 to move within a cylinder 106 also of a non-magnetic material of low thermal conductivity, such as glass reinforced plastics material. The outer end of the cylinder 106 is fixed to the cup 5a which is welded into a hole in the outer vessel 5. The other, inner, end of the cylinder 106 is closed by a retaining ring 107. A coil spring 108 is located about the piston and between the retaining ring 107 and the bore riding ring 105. The spring acts to push the piston 101 back into the cylinder 106.

The piston 101 is preferably hollow. This reduces thermal conduction through the material of the piston. Of course, the piston may be solid, particularly if required to support the necessary mechanical load. Located within a void in the cylinder 106 and preferably immediately below the bearing surface 104 is a deployment mechanism 109. This comprises a disc 110 which includes a step 111 and is rotatable about an axis pin 112. Attached to the disc 110 is a pivot arm 113 carrying at its outer end a ball 114 of ferrous material. An eccentrically located bias riding pin 115 is fixed off axis on the disc 110 and rides as the disc rotates against a leaf spring 116. The leaf spring 116 is fixed between two pins 117 in the cylinder body.

A number of features are provided to reduce heat migration via this mechanism. Firstly, as already described, the materials are chosen to reduce this. In this case, the use of predominantly glass re-enforced plastics material for the cylinder 106 and piston 101. Secondly, the piston inner end area is reduced relative to the rest of the piston, to reduce the transfer of heat to the piston. Thirdly, a layer of reflective foil 118 may be applied to the innermost portion of the cylinder 106. Fourthly, the piston contact area to the cylinder is reduced by the use of the bore riding ring 105 and bearing surface 104. Preferably, the piston wall does not touch the cylinder other than by bore riding ring 105 and bearing surface 104.

To reduce heat transfer even further, the end face 103 is preferably thermally connected by a metallic strip or braid 119 to the radiation shield 4. This cools the end of the piston down to the temperature of the radiation shield itself. Further, the reflective layers 6 abut the end 102 of the piston 101. A reflective layer 118a is preferably provided adjacent the piston on the helium vessel 2.

It will be seen that there is a gap 120 in this deployed state between the helium vessel 2 and the end of the piston 103 to cater for expansion and contraction of the components and to avoid heat being continuously conducted directly to the helium vessel from the piston. However, if during transit the helium vessel moves, it will traverse the gap 120 to abut the piston end 103 and mechanical load will be transferred to the outer vessel 5.

When the cooled magnet is safely located at its operating site, the magnets 3 are ramped up, that is to say, current is introduced and a magnetic field is generated. This results in the ferrous ball 114 being attracted inwards towards the helium vessel 2 by the magnetic field. This in turn causes the disc 110 to rotate in the direction of labelled arrow 121. The disc 110 moves against the spring bias provided by the leaf spring 116 against pins 117 until the step 111 is parallel to the end face 104 and the end face falls back into the step under the action of the piston spring 108. This gives the stowed condition of the limiter as shown in FIG. 3. It is accordingly important that the piston 101 is composed of non-magnetic materials, since otherwise it would not retract back into the cylinder 106. Note that in the retracted condition it will be seen that the insulation layers drape somewhat as the gap 120 opens. In this condition the bands 7 provide the necessary support for the helium vessel 2. The piston may retract out of contact with metallic strip or braid 119, so as to remove a path of heat influx to the radiation shield.

While the present invention has been described with particular reference to cooled superconducting magnets for MRI imaging systems, it will be clear to those skilled in the art that the present invention may apply to cryogenically cooled superconducting magnets for any purpose, such as nuclear magnetic resonance spectroscopy, particle acceleration and so forth. Furthermore, while the present invention has been described with reference to superconducting magnets cooled by immersion in liquid helium in a cryogen vessel, it will be apparent to those skilled in the art that the invention may be applied to magnets cooled by other cryogens, such as nitrogen, hydrogen, neon, and so on, as determined by the material of the superconducting magnet. Some cooled superconductive magnets are not cooled by immersion in liquid cryogen in a cryogen vessel. Rather, cooling loops or direct refrigeration may be used. In such arrangements, the present invention may be employed to restrain displacement of the magnet, by arranging the limiters 10 to bear against a mechanically robust part of the magnet structure, such as a mechanical former.

1. A movement limiter for limiting relative movement of a superconducting magnet with respect to an outer vessel within which the magnet is supported by a support structure, the movement limiter having a deployed condition and a stowed condition such that when in the deployed condition, the relative movement of the magnet is limited by the movement limiter and when in a stowed condition, the relative movement is not limited by the movement limiter, wherein the limiter moves between one of the deployed and stowed conditions to the other of the deployed and stowed conditions in response to the generation of a magnetic field by the superconducting magnet.

2. A movement limiter as claimed in claim 1 wherein the limiter comprises a piston operable to move from a deployed position where an inner end of the piston is proximate an abutment for limiting the relative motion of the magnet, to a stowed position where the inner end is relatively remote from the abutment.

3. A movement limiter as claimed in claim 2 wherein the piston is formed of low thermally emissive material.

4. A movement limiter as claimed in claim 2 wherein the piston is formed of low thermally conductive material.

5. A movement limiter as claimed in claim 2 wherein a ferrous material is provided, operably coupled to the piston, such that, upon generation of a magnetic field by a superconducting magnet, the ferrous material is attracted towards the superconducting magnet, providing motive force to move the piston to the stowed condition.

6. A movement limiter as claimed in claim 2 wherein the piston rides in a cylinder on one or more bore riding rings.

7. A cryostat comprising a magnet structure, in spaced apart relationship to an outer vessel, and a movement limiter according to claim 1 arranged to bear against a mechanically robust part of the magnet structure for limiting relative movement of the magnet coils with respect to the outer vessel.

8. A cryostat comprising a set of superconducting magnet coils mounted within a cryogen vessel for containing cryogen for cooling the superconducting magnet coils, an outer vessel containing the cryogen vessel and an insulation structure disposed between the outer vessel and the cryogen vessel, a support structure within the outer vessel for supporting the cryogen vessel in spaced apart relationship to the outer vessel and a movement limiter according to any preceding claim for limiting relative movement of the cryogen vessel with respect to the outer vessel, such that relative movement between the magnet and the outer vessel is limited by the support structure when the limiter is in the stowed condition.

9. A cryostat as claimed in claim 8 wherein the piston is thermally coupled to the insulating structure.

10. A cryostat as claimed in claim 9 wherein the piston is thermally coupled to a radiation shield of the insulating structure.

11. A cryostat as claimed in claim 9 wherein the thermal coupling is provided by a metal strip or braid.

12. A cryostat as claimed in claim 8 wherein the limiter passes through a hole in a radiation shield of the insulating structure, and a reflective layer is provided over at least that portion of the cryogen vessel opposite the hole.

13. A cryostat as claimed in claim 12 wherein a further reflective layer is provided over at least part of the limiter facing the cryogen vessel.

14. A movement limiter for use in a cryostat comprising a piston located within a cylinder and a ferrous material for in use being attracted to a magnet within the cryostat, thereby to move the piston from at least one of a deployed and stowed state to the other of the at least one of a deployed and stowed state.

15. (canceled)

16. (canceled)
